(19) United States
(12) Patent Application Publication
(10) Pub. No.: US 2010/0213156 A1
(43) Pub. Date: Aug. 26, 2010

(54) APPARATUS AND METHOD FOR MIXING INFANT FORMULA

(76) Inventor: Nicole Belnap, Vernal, UT (US)

Correspondence Address: Kunzler Needham Massey & Thorpe, 8 EAST BROADWAY, SUITE 600, SALT LAKE CITY, UT, 84111, US

(21) Appl. No.: 12/713,150

(22) Filed: Feb. 25, 2010

Related U.S. Application Data
(60) Provisional application No. 61/155,495, filed on Feb. 25, 2009.
(60) Provisional application No. 61/155,490, filed on Feb. 25, 2009.

(51) Int. Cl. B65D 1/04; A61J 9/00

(52) U.S. Cl. 215/6; 215/11.1

(57) ABSTRACT

An apparatus and method for storing, mixing, and delivering a powder solid and a fluid such as baby formula and water without the risk of product contamination or product expulsion to the surrounding environment. The apparatus is used by placing the powder formula into a specially designed compartment, joining the compartment with another compartment configured to store a liquid, filling the second compartment with a liquid, and sealing the system together. Once mixing and activation is completed, the two compartments are twisted in relation to one another, and the two separate substances are now allowed to flow freely and mix. The product can now be served to the child.

### CROSS-REFERENCES TO RELATED APPLICATIONS

This application claims priority to U.S. Provisional Patent Application No. 61/155,490 entitled “Container Communication Apparatus and Method” and filed on Feb. 25, 2009, for Nicole Belnap, which is incorporated herein by reference. This application also claims priority to U.S. Provisional Patent Application No. 61/155,495 entitled “Apparatus and Method for Mixing Infant Formula” and filed on Feb. 25, 2009, for Nicole Belnap, which is incorporated herein by reference. U.S. patent application Ser. No. ______ entitled “Apparatus, System and Method for Selectively Mixing Two Substances” and filed on Feb. 25, 2010, for Nicole Belnap, is incorporated by reference as if fully set out herein.

### BACKGROUND OF THE INVENTION

1. Field of the Invention

This invention relates to baby bottles and storage of formula and water, and more particularly to mixing of nutrition formula and water while minimizing time and effort.

2. Description of the Related Art

Baby bottles have long been used to deliver nutrition to small children. Bottles can carry fluid in many forms. While some fluids such as water or drinks can be stored at room temperature for extended periods of time without fear of spoiling, other fluids have a very limited life. Once the powder formula is mixed and activated with water, it has only a few hours before it will spoil. The mixing of the powder formula with water poses many challenges, especially when one is away from home or kitchen. There is the problem of measuring out an appropriate amount of powder formula, adding it to the bottle, and mixing the two substances into one while maintaining cleanliness on the outside of the bottle as well as sanitary conditions on the inside of the bottle. Keeping this action sanitary and clean takes time and effort.

Time is very valuable in the preparation of formula, since small children are not able or willing to wait long for nutrition, making the situation sometimes very uncomfortable for both the caregiver as well as people around the hungry child. The frustration of the caregiver and child is increased when appropriate facilities are not available to mix the formula and water. This is especially germane in a crowded airplane, restaurant, or other public setting where one may be required to feed a child.

### SUMMARY OF THE INVENTION

From the foregoing discussion, it is apparent that a need exists for a device that will store powder formula and water, and allow the two to be mixed efficiently and cleanly when desired.

The present invention has been developed in response to the present state of the art, and in particular, in response to the problems and needs in the art that have not yet been fully solved by currently available baby bottles. Accordingly, the present invention has been developed to provide an apparatus, and method for storing, mixing, and delivering baby formula that overcome many or all shortcomings in the art.

In one aspect of the invention, an apparatus for selectively mixing and delivering formula to a child, the apparatus comprises two containers with a passage that is disposed between the two containers. The passage is blocked and can be electively moved and unblocked. The individual containers are generally cylindrical, making the apparatus cylindrical as well. The apparatus also comprises of snap rings and grooves that are disposed along the edges of the containers allowing the containers to be joined and mated. The rings and grooves also allow for the containers to rotate in relation to one another. The rings and grooves are configured in a way to allow for the rotation to be selectively limited by the operator of the device.

The apparatus also comprises a membrane that is disposed between the two compartments of the apparatus. This membrane is configured to selectively block the passage of water and formula between the two compartments. The membrane that separates the two compartments comprises passages and blockages. The blockage can be configured to wedge into one of the compartments and seal the passage. Once the blockage is established, communication of the formula and water is effectively inhibited.

In a further embodiment of the invention, a method of storing, mixing, and delivering baby formula to a child includes filling a first compartment with water. The first compartment is then sealed with a plug and joined with a second compartment that has been filled with the powder formula. Once prepared and joined, the two compartments effectively separate and store formula powder and water. Once activation is desired, the two compartments are rotated by the user and twisted in relation to one another. By twisting the two compartments, the blockage is removed, and the passage is aligned. Aligning the passage, allows for the powder formula and water to freely flow and mix, activating the formula drink. Once activated, the formula can be served to a child through a nipple located at the top of the apparatus.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a perspective view of one embodiment of an infant formula mixing apparatus according to the present invention;

FIG. 2 is an exploded perspective view of the apparatus of FIG. 1;

FIG. 3 is an exploded perspective view of an embodiment of an infant formula mixing apparatus according to the present invention;

FIG. 3A is a bottom plan view of an embodiment of a membrane plug for use in an infant formula mixing apparatus according to the present invention;

FIG. 3B is a bottom plan view of an embodiment of a membrane for use in an infant formula mixing apparatus according to the present invention;

FIG. 3C is a cross-sectional view along lines 3C in FIGS. 3A and 3B, with the membrane and membrane plug being placed adjacent each other, as in operation of the apparatus;

FIG. 4 is an exploded perspective view of the lower portion of an infant formula mixing apparatus according to the present invention;

FIG. 5 is a perspective view of an embodiment of an infant formula mixing apparatus according to the present invention;

FIG. 6 is a schematic flow chart diagram illustrating an embodiment of a method of preparing, mixing, and delivering baby formula according to the present invention;

FIG. 7 is a top plan view of an embodiment of a membrane and membrane plug for use in an infant formula mixing apparatus according to the present invention;

FIG. 8 is a top plan view of another embodiment of a membrane and membrane plug for use in an infant formula mixing apparatus according to the present invention;

FIG. 9 is a perspective view of an embodiment of a sealing mechanism according to the present invention;

FIG. 10 is a side view of the mechanism of FIG. 9;

FIG. 10A is a cross-sectional view of the mechanism of FIG. 9;

FIG. 11 is a side elevational view of an embodiment of an infant formula mixing apparatus according to an embodiment of the present invention;

FIG. 11A is a cross section view of the apparatus of FIG. 11;

FIG. 12 is a perspective view of the second compartment of the apparatus of FIG. 11;

FIG. 12A is another perspective view of the second compartment of the apparatus of FIG. 11;

FIG. 12B is a top view of the second compartment of the apparatus of FIG. 11;

FIG. 12C is a side view of the second compartment of the apparatus of FIG. 11;

FIG. 12D is a bottom view of the second compartment of the apparatus of FIG. 11;

FIG. 13 is a perspective view of the intermediate piece of the apparatus of FIG. 11;

FIG. 13A is another perspective view of the intermediate piece of the apparatus of FIG. 11;

FIG. 14 is a side elevational view of an embodiment of an infant formula mixing apparatus according to the present invention;

FIG. 15 is a cross section view of the apparatus of FIG. 14;

FIG. 16 is a perspective view of the first compartment of the apparatus of FIG. 14;

FIG. 16A is a perspective view of the first compartment of the apparatus of FIG. 14;

FIG. 17 is a perspective view of a sleeve of the apparatus of FIG. 14;

FIG. 17A is a side view of the sleeve of the apparatus of FIG. 14;

FIG. 18 is a side view of an embodiment of an infant formula mixing apparatus according to the present invention;

FIG. 18A is a cross section view of the apparatus of FIG. 18.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize that the invention may be practiced without one or more of the specific details, or with other methods, components, materials, and so forth. In some instances herein certain structures, materials, or operations are not shown or described in detail to avoid obscuring aspects of the invention.

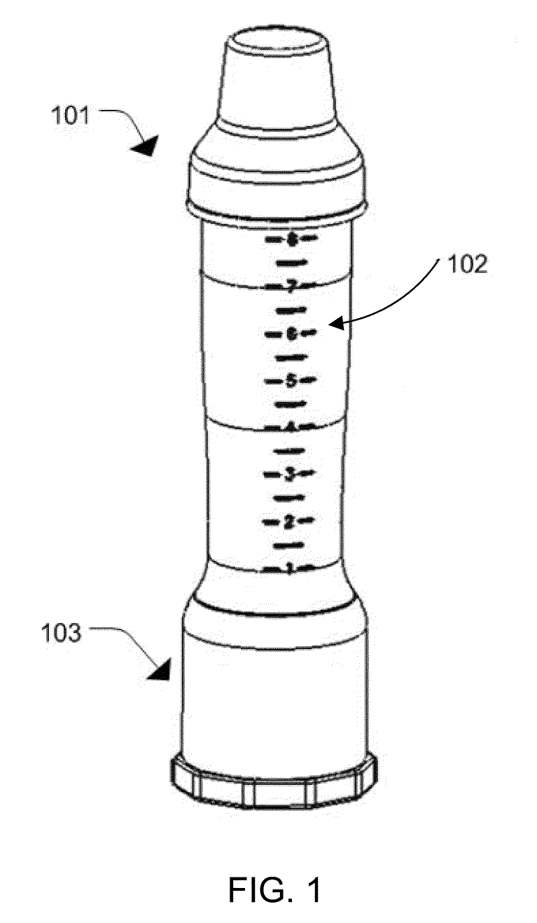

FIG. 1 illustrates an embodiment of an infant formula mixing apparatus or baby bottle 101, comprising a first compartment 102 configured to store a liquid, and a second compartment 103 configured to store a solid. Alternative configurations of the first compartment 102, some of which are shown in later figures, may take shapes other than cylindrical, such as extruded polygons as known to those skilled in the art.

The second compartment 103 may also take different shapes than the one shown, and can also be configured to accept the solid in various forms such as, but not limited to, powder, pressed powder, and disposable powder cartridges as known to those skilled in the art.

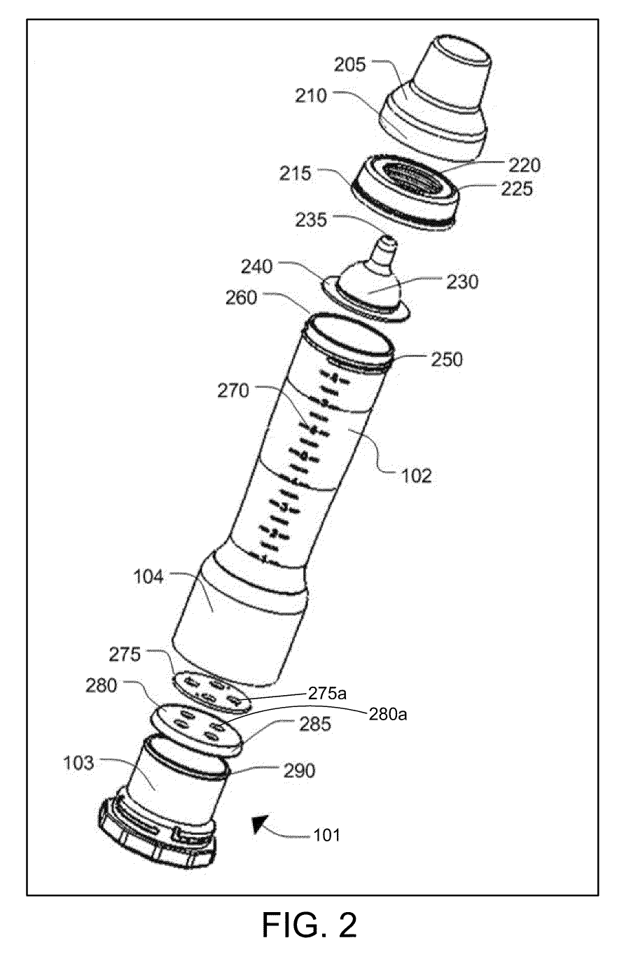

FIG. 2 further illustrates the apparatus of FIG. 1. As shown, a lid 205 is configured to be placed adjacent a retention ring 225 and selectively joined to the retention ring 225 by manually manipulating a retention snap ring 210 disposed on the lid 205 over a retention snap ring 215 disposed on the retention ring 225. The diameter of the retention snap ring 210 is of sufficient diameter to ensure that it can be manually manipulated over the retention snap ring 215, but small enough to ensure that once the snap retention ring 210 is placed over the snap retention ring 215 it cannot be unintentionally removed.

A nipple 230 with a nipple passage 235 is disposed through the center of the retention ring 225. A nipple base 240 is disposed on the nipple 230 as shown, and is configured as a seal between the top edge 260 of the first compartment 102 and the retention ring 225. The lid 205 is configured to hide the nipple 230 from view and seal the nipple passage 235 from contact with the surrounding environment for hygiene and aesthetic purposes. The top of the nipple 230 is configured to be firmly seated against the interior top of the lid 205 in order to close and seal the nipple passage 235.

Threads 220 are disposed on the inside of the retention ring 225, and are configured to be the same size and pitch as threads 250 near the top edge 260 of the first compartment 102 in order to thread within each other. The retention ring 225 is configured to attach and seal the nipple 230 to the top edge 260 of the first compartment 102. One skilled in the art may choose to not use threaded inclusions, but other means such as friction or snap rings. One skilled in the art may also choose a permanent seal by means of molding the entire assembly, welding the individual pieces together, or join the individual pieces with a chemical bond.

A plurality of volume indicators 270 are disposed on the first compartment 102 to represent volume using the metric system, English system, or as a percentage of volume available or consumed.

A membrane plug 275 and membrane 280 are disposed between the first compartment 102 and the second compartment 103. The membrane plug 275 is a disc, but it can be configured in any suitable manner as to fit inside of a base portion 104 of the first compartment 102 and form a functional seal. A retention ridge 290 is disposed on the top edge of the second compartment 103 and configured to connect and seal a retention lip 285 disposed on the membrane 280. The ridge 290 is configured to snap over the retention lip 285. The membrane 280 and second compartment 103 can be joined as described in the current embodiment, or one skilled in the art may choose to mate the devices by alternate means, such as joining multiple threaded inclusions and twisting the membrane 280 onto the second compartment 103. In an alternative embodiment, the membrane 280 and the second compartment 103 may consist of a joined unit that would not be end-user serviceable, as a disposable cartridge system pre-filled with baby formula. A removable seal (not shown) can be attached to the membrane 280 by a removable adhesive to seal the top of the membrane 280.

The membrane 280, and other membranes described herein, may be stiff or flexible, as needed in the particular application of the invention.

The membrane plug 275 contains a plurality of apertures 275a, and the membrane 280 contains a plurality of apertures 280a, each of the apertures 275a being positioned to be axially coextensive with an aperture 280a, allowing communication between the first compartment 102 and second compartment 103 when the membrane 280 and membrane plug 275 are in a certain rotational position relative to each other. At another or other rotational positions, the apertures 275a are positioned such that the membrane 280 blocks them, and the apertures 280a are blocked by the membrane plug 275, preventing communication between the first compartment 102 and second compartment 103.

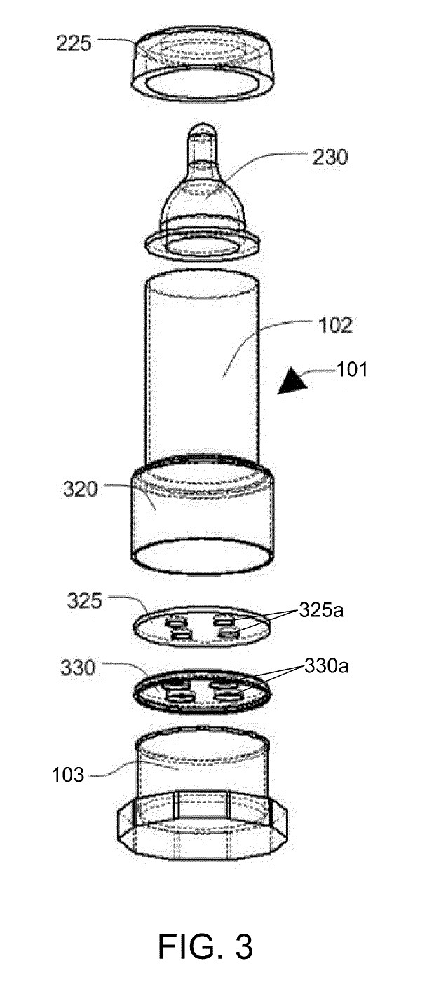

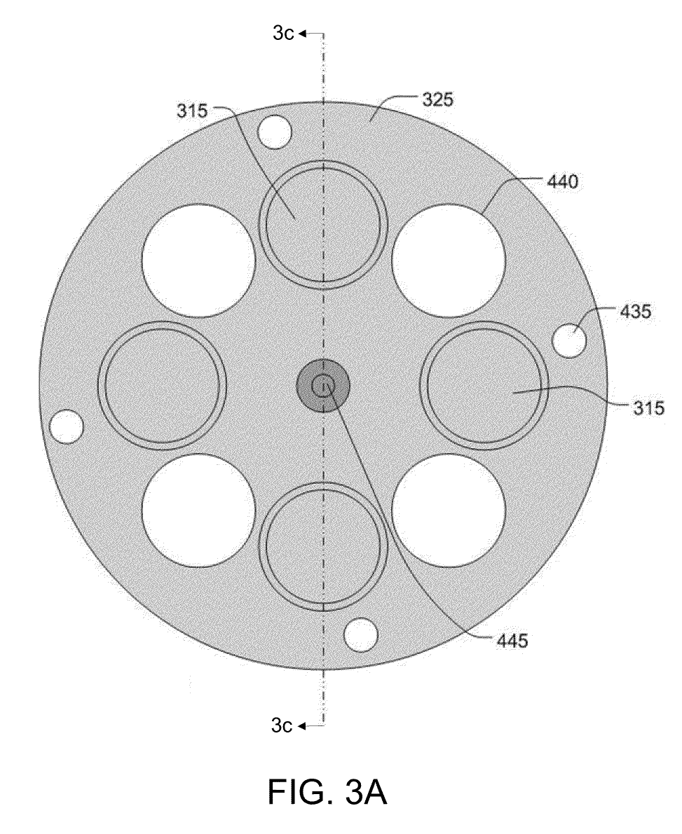

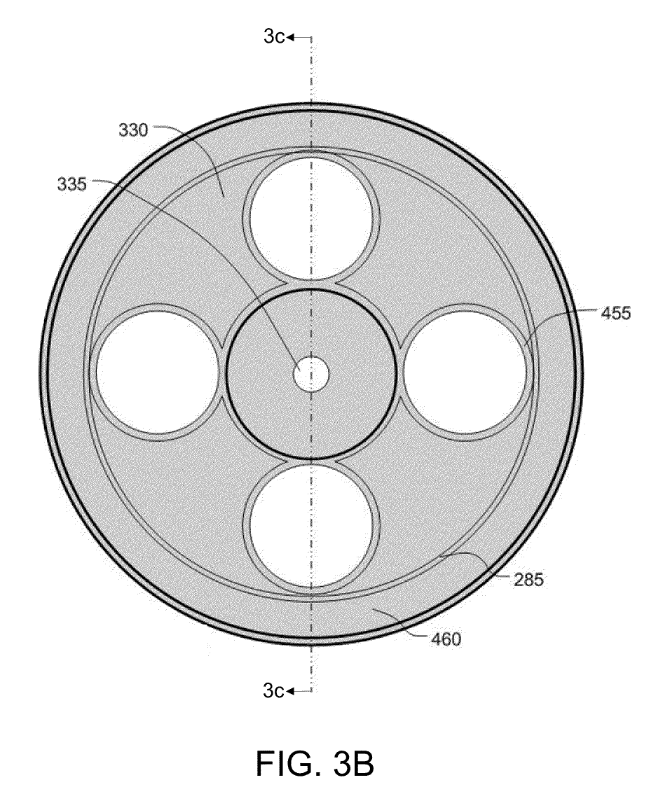

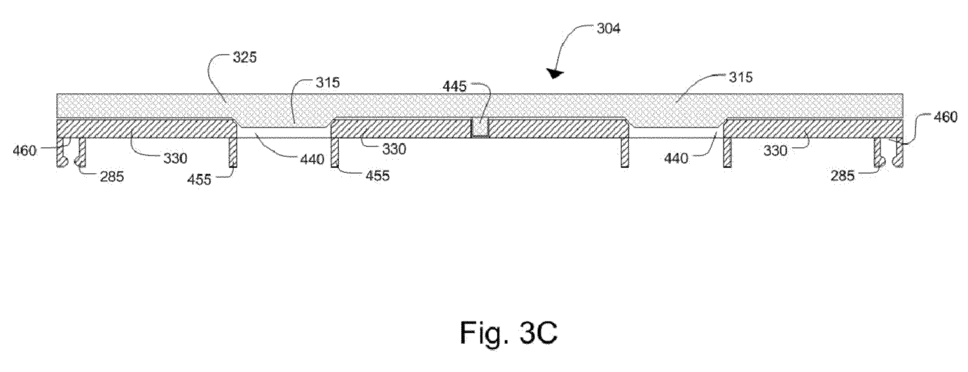

FIG. 3 illustrates an embodiment of an infant formula mixing apparatus or baby bottle 301, similar to the bottle 101, comprising the retention ring 225, the nipple 230, the first compartment 102, a bottom section of the first compartment 320, a membrane plug 325, a membrane 330, and the second compartment 103. The first compartment 102 is cylindrical in nature, but can be shaped in other ways to help a user better manipulate the apparatus, such as in a toroid. The exterior of the first compartment 102 might also contain inclusions, bumps, and displacements, either integrally or as a veneer, overlay, cover, or a new surface configured to be removable or non-removable, which surface may, for example, comprise a soft rubber-like compound.

A portion of the base of the second compartment 103 is an extruded polygon. One skilled in the art may choose to configure the base in a variety of ways as to better help the user hold and manipulate the apparatus, such as cylindrical. The base may configured in further embodiments so as to comprise a veneer, overlay, cover, or new surface configured to be removable or non-removable, such as a soft rubber-like compound so as to assist a user in the manipulation and activation of the apparatus, especially when wet.

The membrane plug 325 contains apertures 325a, and the membrane 330 contains apertures 330a, which are configured and operate similarly to the apertures 275a and 280a of FIG. 2.

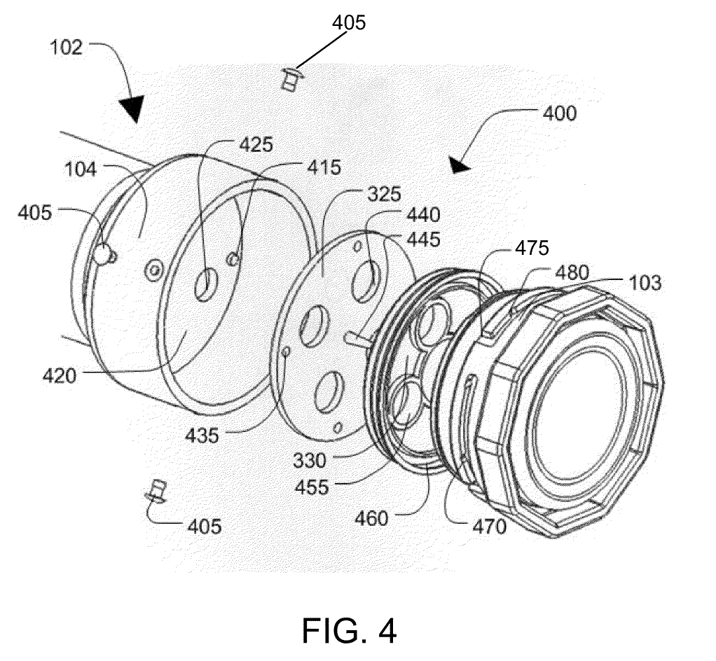

FIG. 4 depicts an embodiment of the lower section of an infant formula mixing apparatus or baby bottle 400, which is similar to bottle 101, showing a detailed embodiment of the mechanism for rotating and locking the membrane and membrane plug to allow or prevent communication between the upper and lower compartments. In FIG. 4, a plurality of alignment pins 415 are disposed on a blocking wall 420, which blocking wall 420 is disposed between the bottom of the first compartment 102 and the base 104. The blocking wall 420 comprises a plurality of passages 425 which allow for communication between the first compartment 102 and the base 104. The passages according to the current embodiment are represented as being mostly cylindrical, however, one skilled in the art may configure the passages in a variety of ways; the blocking wall 420 and blocking wall passages 425 may be configured about the common axis with just enough blocking wall 420 to maintain structural integrity and house the alignment pins 415. The base 104 comprises a plurality of radially extending retaining pins 405. The membrane plug 325 comprises a plurality of alignment holes 435 configured to accept the alignment pins 415. The membrane plug 325 further comprises a plurality of passages 440 configured according to the present invention to be aligned with the passages 425 of the blocking wall 420. The membrane plug 325 further comprises a rotation pin 445 disposed vertically in its center. The membrane 330 is disposed between the membrane plug 325 and the second compartment 103. The membrane 330 comprises membrane passages 455 and a retention channel 460, the membrane passages 455 positioned to line up with the passages 440 when the membrane and membrane plug are in a certain rotational position.

According to one embodiment, the second compartment 103 includes a plurality of alignment grooves 470, a plurality of alignment entrance grooves 475, and a plurality of inhibiting inclusions 480. The grooves 470 are configured to accept the pins 405 such that the pins 405 slide into the grooves 470; as the second compartment 103 is rotated relative to the first compartment 102, the pins 405 slides through the grooves 470. When a pin 405 encounters an inhibiting inclusion 480, the pin 405 rests within the inhibiting inclusion 480 restricting, to a certain extent, further rotation of the second compartment 103 relative to the first compartment 102. Additional rotational force, applied to the second compartment 103, causes the pin 405 to disengage the inhibiting inclusion 480 and allow the second compartment 103 to rotate further relative to the first compartment 102.

One of skill in the art will recognize that in certain embodiments the pins 405 may comprise a separate component inserted through the wall of the base 104. In other embodiments the base 104 may include protrusions (not shown) extending from the interior of the wall of the base 104 that are configured to slide within groove 470 of the second compartment 103.

The structure of pins and grooves helps maintain the membrane and membrane plug in desired rotational positions relative to each other in order to line up the passages 440 and 455 to allow for communication between the compartments 102 and 103, with other rotational positions preventing the passages 440 and 455 from lining up and preventing communication between the compartments 102 and 103.

FIG. 3A is a bottom view of the membrane plug 325, which comprises a plurality of plug inclusions 315 as well as the alignment holes 435, passages 440, and rotation pin 445 as described in FIG. 4. The plug inclusions 315 are configured to snap into and retain the passages 455 in rotational position when communication between the compartments 102 and 103 is desired to be prevented.

FIG. 3B is a bottom view of the membrane 330, comprising the membrane passage openings 455 and retention channel 460, and a rotation pin receiving hole 335 and retention lip 285.

FIG. 3C is a view along line 3c of FIGS. 3A and 3B, showing a cross section of the membrane plug 325 and membrane 330 in engagement with each other. In operation, the membrane plug 325 rotates around the rotation pin 445 to alternately open and close the membrane passages 440 to allow material such as water or formula to flow through the membrane passages 440. In the closed position the plug inclusions 315 are received within the membrane passages 440 in the membrane 330. The surface of the membrane plug 325 that comes in contact with the membrane 330 is substantially planar, other than the plug inclusions 315. The plug inclusions 315 are raised with respect to the substantially planar surface of the membrane plug 325.

The plug inclusions 315 are shaped to be received within the membrane passages 440 to stop flow of any material such as water or formula through the membrane passages 440 in certain rotational positions. When the second compartment 103 is rotated with respect to the first compartment 102 the plug inclusions 315 are displaced from within the membrane passages 440. To mix the material contained within the second compartment 103 with the material contained within the first compartment 102, the second compartment 103 is rotated to a position that aligns the membrane passages 440 with the membrane passage openings 455. Material can then freely travel through the membrane passages 440 between the first compartment 102 and the second compartment 103.

The membrane retention channel 460 on the membrane 330 includes a retention lip 285 that receives a top edge of the second compartment 103. In certain embodiments the top edge of the second compartment 103 includes a groove that receives the retention lip 285 on the membrane to hold the membrane onto the second compartment 103.

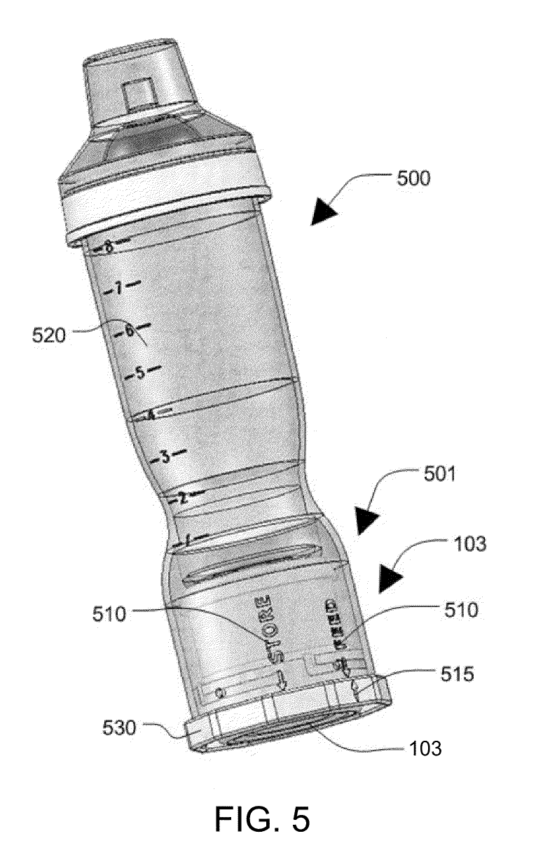

FIG. 5 shows an infant formula mixing apparatus 500 comprising a first compartment 520, a second compartment 103, a bottom 501 of the first compartment 520, a plurality of rotational position indicators 510 and 515 located on the compartment 103 and a base 530 of the compartment 103, respectively, and a plurality of rotational position indicators 510 located on the bottom of the first compartment 520. In FIG. 5, the bottom 501 of the first compartment 520 includes two rotational position indicators 510 and the base 530 of the second compartment 103 includes a single rotational position indicator 515. In certain embodiments the base 530 of the second compartment 103 may include two rotational position indicators 515 and the bottom 501 of the first compartment 520 may include a single rotational position indicator 510. In other embodiments both the base 530 of the second compartment 103 and bottom 501 of the first compartment 520 may include more than one rotational position indicator 515 or 510 respectively. One skilled in the art may configure the indication arrow 515 in a variety of ways. The position indicators 510 and 515 may comprise a dot, a line, or various other marks, symbols, inclusions, or formations such that the lateral position of the base 530 relative to the first compartment 520 is clearly communicated to the end user.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

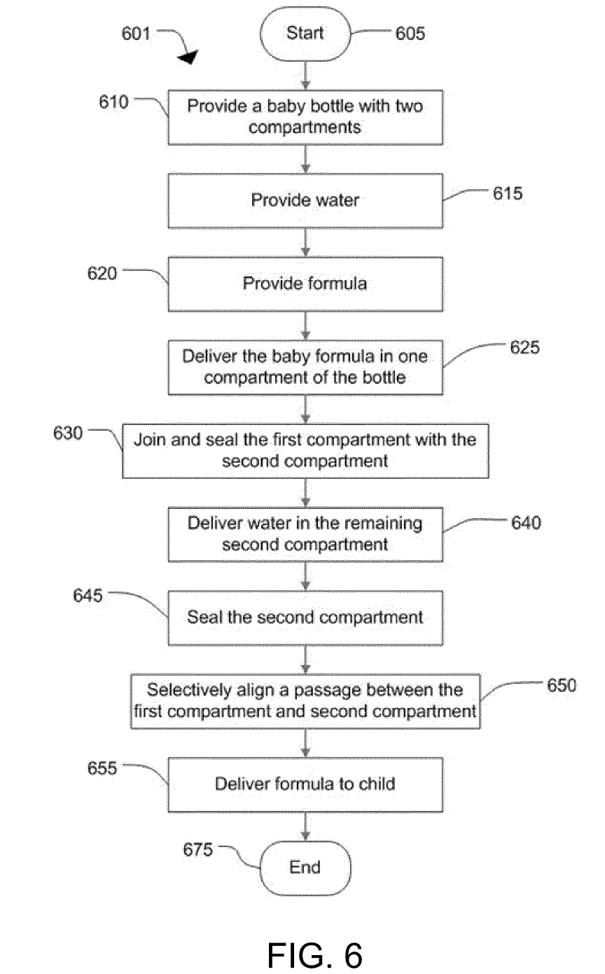

FIG. 6 illustrates an embodiment of a method 601 of storing, mixing two substances, and delivering the mixed product to a child in accordance with the present invention. The apparatus embodiments described previously may be used in the method 601.

The method 601 begins 605, and a baby bottle comprising two compartments is provided 610. Water is provided 615 for use in mixing with a baby formula. Baby formula is also provided 620. The baby formula is delivered 625 into one compartment of the bottle in the desired amount. The compartments are joined and sealed 630, with a membrane and membrane plug sandwiched between the compartments, prohibiting material from traveling between the compartments when plug inclusions on the membrane plug are positioned within passages on the membrane. Water is delivered 640 in the desired amount to the remaining compartment, which is then sealed 645, such as by attaching a nipple and nipple-retaining ring to the compartment.

Once fluid communication is desired, a passage is opened 650 between the two compartments by rotating the compartments relative to each other, aligning passages in the membrane and membrane plug. The formula and the water are mixed and the resulting formula is then delivered 655 to the child. The method then ends 675.

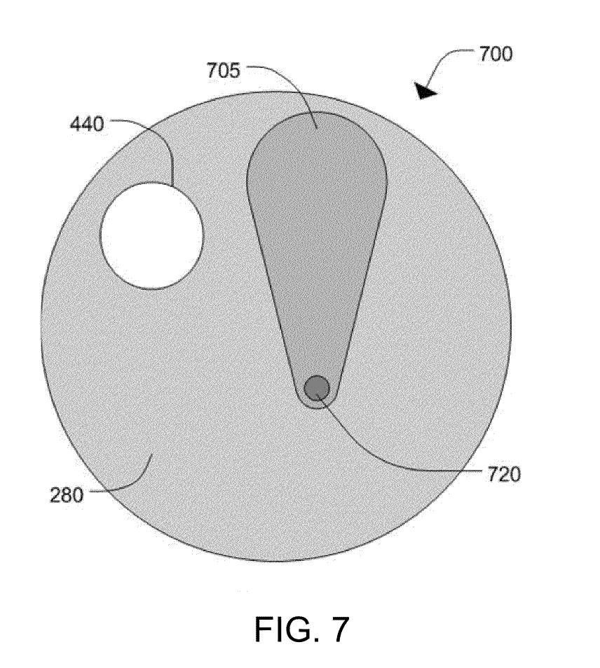

FIG. 7 depicts an alternative embodiment of a sealing mechanism 700 for use in an infant formula mixing apparatus such as those depicted above. In this embodiment, rather than rotating a co-extensive membrane and membrane plug relative to each other to align and open passages on the membrane and membrane plug, a membrane between the compartments is provided with a passage that is opened and closed by a non-coextensive membrane plug. The sealing mechanism 700 comprises a membrane 280, a membrane passage 440, a membrane plug 705, and a membrane plug pivot 720 attached to the membrane 280. As will be apparent to someone skilled in the art, the size, quantity, location, and disposition of the membrane plug 705, the membrane passage 440, and the membrane pivot 720 on membrane 280 can be arranged to provide a varying volume of communication of water and formula when the mechanism is activated.

The membrane plug 704 is configured to rotate around the membrane plug pivot 720 to alternately open and close the membrane passage 440.

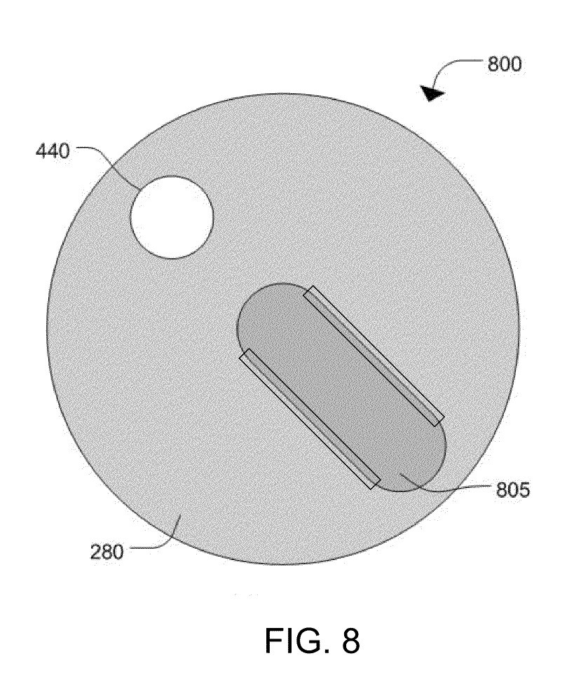

FIG. 8 illustrates another embodiment of a sealing mechanism 800 according to the present invention. In FIG. 8 the membrane plug 805 is disposed adjacent and attached to the membrane 280, and configured to slide laterally with respect to the membrane 280. In certain embodiments the membrane plug 805 is received between two retention flanges 810 that operate to hold the membrane plug 805 next to the membrane 280 and allow the membrane plug to slide laterally between the retention flanges 810. The membrane plug 805 is disposed on the membrane 280 to selectively block the membrane passage 440 when laterally disposed over membrane passage 440. The passage 440 and membrane plug 805 can be configured in size, shape and quantity by someone skilled in the art as to vary the flow of fluid and powder baby formula through the passage 440.

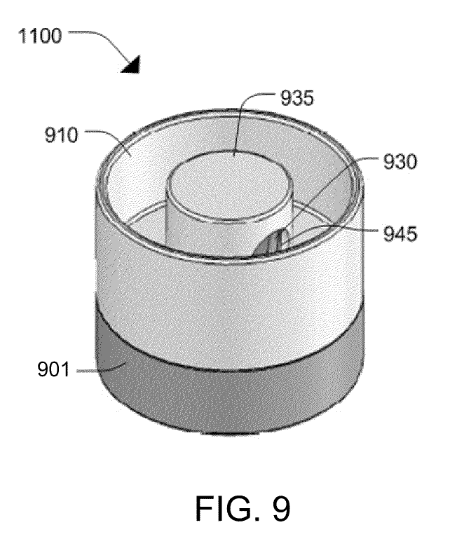

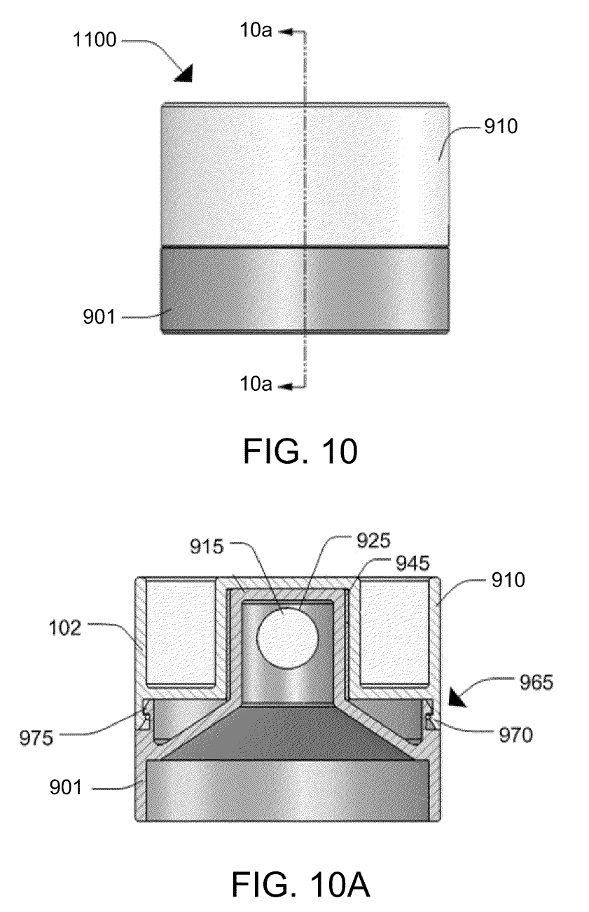

FIGS. 9, 10, and 10A illustrate another embodiment of a sealing mechanism for use between compartments of an infant formula mixing apparatus according to the present invention.

FIG. 9 depicts an embodiment of an mechanism 1100 for sealing two compartments, such as the first compartment 102 and the second compartment 103. In certain embodiments an upper section 910 of the sealing mechanism 1100 is configured to mate with the first compartment 102 in using threads, a snap fit, or other mating method as is known in the art. The upper section 910 of the sealing mechanism 1100 is configured to be integral and mated with a lower section 901. In certain embodiments the lower section 901 is configured to mate with the second compartment 103 using threads, a snap fit, or other mating method as is known in the art. In certain embodiments the upper section 910 may comprise an integral component of the first compartment 102 and the lower section 901 may comprise an integral component of the lower section 901 such that the upper section 910 and the lower section 901 may be molded as part of the first compartment 102 and second compartment 103 respectively.

A passage 930 is disposed within a vertical extrusion 935 of the upper section 910. The first compartment 102 and the second compartment 103 are effectively and selectively separated and sealed from each other by a seal 945 on an extrusion (discussed below) in the lower section 901. The seal 945 is similar in size, displacement, as well as disposition to that of the passage 915. The extrusion in the lower section 901 includes a passage similar in size, displacement, as well as disposition to that of the passage 915.

The seal 945 may be made of a material that comprises a friction coefficient less than that of the material of the upper section 910 relative to the material of the lower section 901 such that the reduced coefficient of friction between the upper section 910 and the lower section 901 reduces the torsional force required to selectively manipulate the passage 915. In certain embodiments the seal 945 can be configured to be removable and serviceable by the user. In another embodiment the seal 945 can be an integral and permanent fixture of the upper section 910 or the lower section 901. The seal 945 may be integrated and mated with the upper section 910 or the lower section 901 by either chemical or physical means, or a combination thereof.

FIG. 10 is a side view of an embodiment of the sealing apparatus 1100 of FIG. 9. The upper section 910 is disposed adjacent to the lower section 901. The upper section 910 is disposed superior to the lower section 901 when the apparatus 1100 is connected to the first compartment 102 and the second compartment 103 and the bottle 200 is oriented with the nipple 230 at the top. One of skill in the art will recognize that in certain embodiments the upper section 910 and the lower section 901 may be reversed, with the lower section 901 connected to the first compartment 102 and the upper section 910 connected to the second compartment 103.

FIG. 10A is a cross section view taken along line 10a of FIG. 10, showing a passage 915 disposed within the lower section 901. A seal 945 is also shown disposed between the first upper section 910 and the lower section 901. The passage 915 is of substantially the same size and shape as the passage 930, and the passages are configured to align with each other upon rotation of the upper and lower sections 910 and 901 to a certain point relative to each other. By the same token, the passages 915, 930 come out of alignment and are sealed against the seal 945 upon further rotation of the upper and lower sections 910 and 901.

It can be seen that the same principle of rotation used in previously described embodiments to alternately open and seal the passages between the compartments is used in this embodiment as well, with the primary difference being that in this embodiment the passages are disposed on vertical extrusions of the upper and lower sections 910, 901, rather than horizontally on a membrane and membrane plug.

The base of the upper section 910 includes a ring 970 that circumscribes the base of the upper section 910. Similarly, the second lower section 901 includes a ring 975. The ring 975 of the lower section 901 circumscribes the lower section 901.

The ring 970 of the upper section 910 is configured to oppose and accept the ring 975 of the lower section 901. The ring 970 of the upper section 910 and the ring 975 of the lower section 901 may also be configured in successively increasing and decreasing diameters configured to accept on another and progressively form a tighter physical seal and a mechanical mate as progressive rings 970 or 975 are disposed into progressively deeper channels.

The materials and fit between the ring 970 and channel of the upper section 910 and the ring 975 and channel of the lower section 901 as represented in FIG. 10A are configured to moderate the torsional forces and resulting rotational motion of the upper section 910 in relation to the lower section 901.

The ring 970 and channel of the upper section 910 and the ring 975 and channel of the lower section 901 may be configured by one skilled in the art to comprise a material different than that of the rest of the body of the upper section 910 or the lower section 901, such as to configure the ring 970 and channel of the upper section 910 and the ring 975 and channel of the lower section 901 to limit the coefficient of friction between the upper section 910 and the lower section 901 while torsional force is applied to the lower section 901 in relation to the upper section 910. In certain embodiments the material of the ring 970 and channel of the upper section 910 and the ring 975 and channel of the lower section 901 may be flexible and malleable enough to allow the user to easily mate the upper section 910 with the lower section 901 while limiting undesired separation of the first compartment 102 from the second compartment 103.

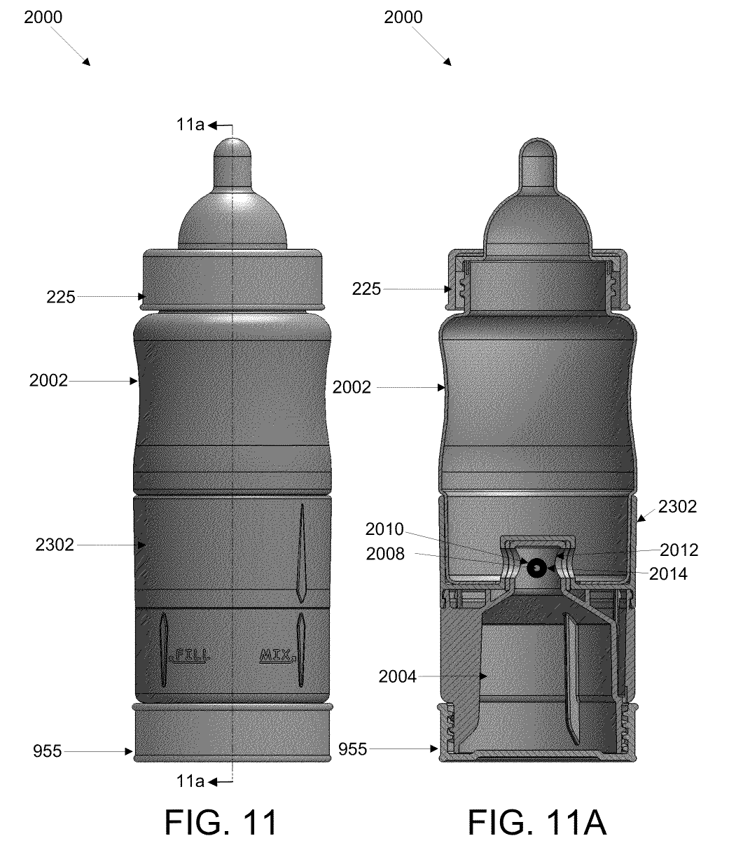

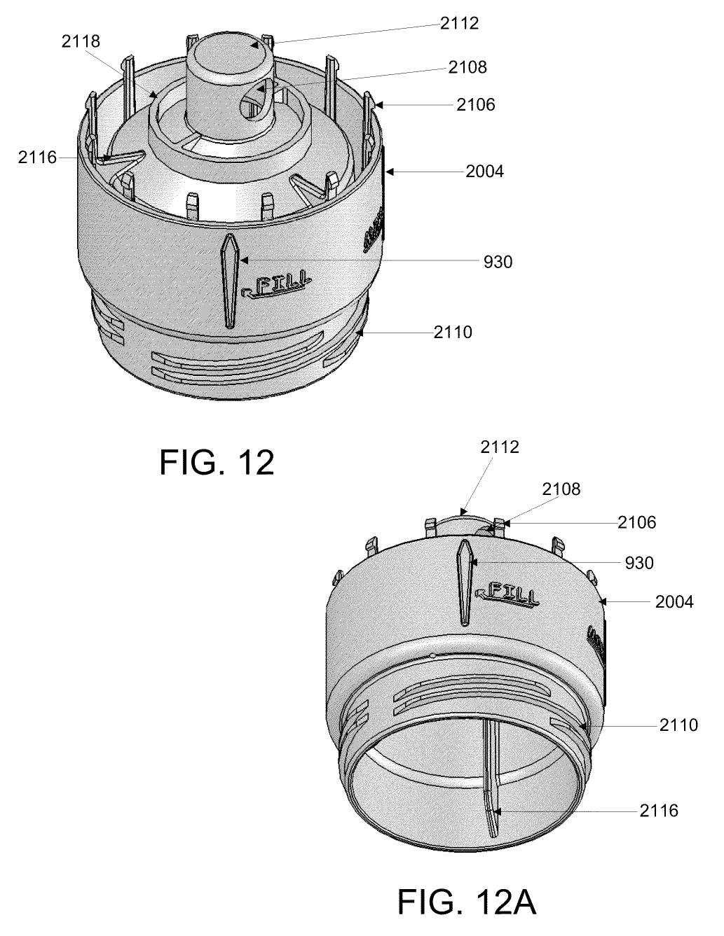

FIGS. 11-13A show another embodiment of an infant formula mixing apparatus according to the present invention, with a vertically-oriented seal and communication passage between the compartments.

FIG. 11 is a side view of the apparatus 2000 comprising a first compartment 2002, a nipple retention ring 225, a base 955, and intermediate piece 2302, among other components. In certain embodiments the first compartment 2002 comprises a compartment for containing a liquid. In other embodiments the first compartment 2002 may be configured to store a solid in various forms such as, but not limited to powder, pressed powder, and disposable powder cartridges as known to someone skilled in the art. The nipple retention ring 225 may be configured to retain a nipple in substantially the same manner as described above in relation to FIG. 2. In certain embodiments the base 955 is configured to be removed from the apparatus 2000 to allow a second compartment to be filled with a liquid or a powder.

FIG. 11A is a cross sectional view of the apparatus 2000 taken along line 11a of FIG. 11. In certain embodiments the apparatus 2000 comprises a first compartment 2002, a second compartment 2004, a nipple retention ring 225, a base 955 disposed on the bottom of the second compartment 2004, a passage 2008 disposed between the first compartment 2002 and the second compartment 2004, a multiple stage valve 2010 disposed within the passage 2008, a vertical extrusion 2012 of the second compartment 2004 configured to receive the passage 2008, and multiple stage valve 2010 and a seal disposed between and configured to form an effective seal 2014 between the first compartment 2002 and the second compartment 2004. The elements of the embodiment illustrated in FIG. 11A will be further discussed below. In general, similarly to embodiments described above, the passage 2008 is opened or closed by rotating the compartments 2002 and 2004 relative to each other so as to align or not align the apertures comprising the passage.

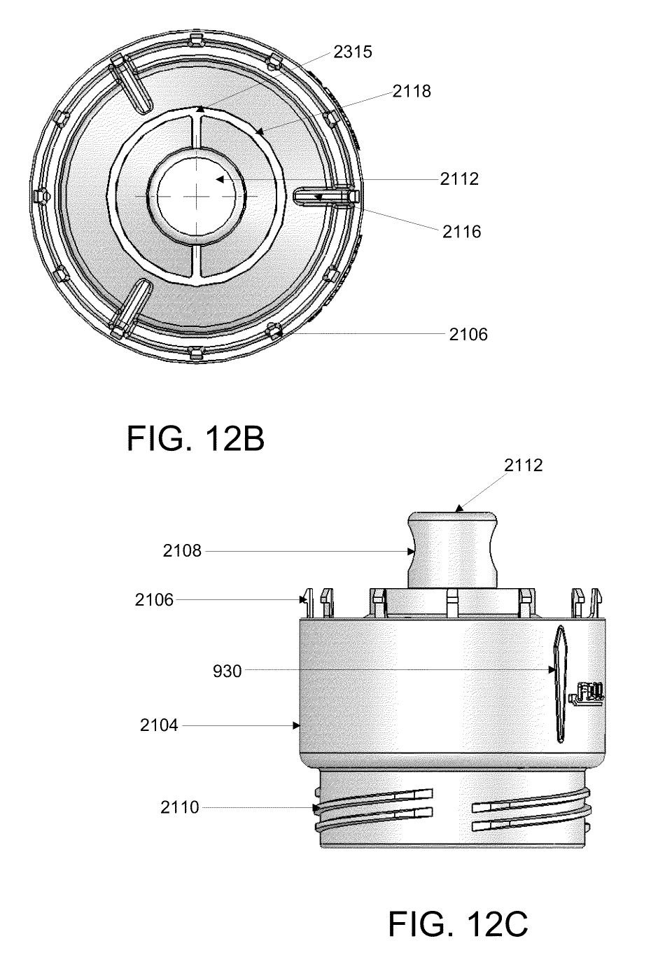

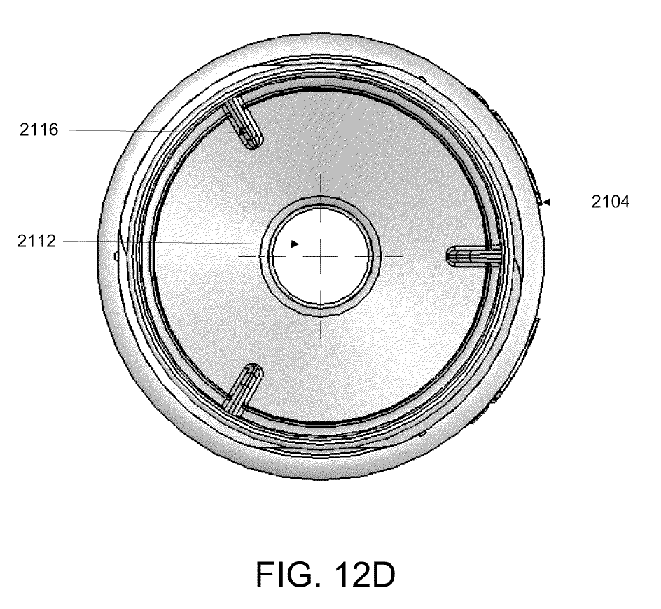

FIGS. 12 and 12A are perspective views of the second compartment 2004. The threading 2110 at the bottom of the second compartment 2004 attaches the base 955 to the second compartment 2004. Rotational position indicators 930 may be included on the outside of the second compartment 2004 to indicate its rotation position in a manner substantially similar to the rotational position indicators 510 and 515 of FIG. 5.

A plurality of fingers 2106 attach the second compartment 2004 to the first compartment 2002, illustrated in FIGS. 11 and 11A, to secure the second compartment 2004 to the first compartment 2002. Clips 2116 may provide further support to one or more of the fingers 2106.

A vertical extrusion 2112 extends up from the center of the second compartment 2004 and includes a passage 2108 through which the contents of the second compartment 2004 may communicate with the contents of the first compartment 2002 through a similar passage disposed in the first compartment 2002. The ridge 2118 around the vertical extrusion 2112 serves to provide support and align the second compartment 2004 with the first compartment 2002 as the compartments are attached.

The clip 2116 extends from the top of the second compartment 2004 to just above the bottom of the second compartment 2004 for further support of one or more of the fingers 2106. Material such as baby formula or water may be contained within the second compartment 2004.

FIG. 12B is a top view of the second compartment 2004. The fingers 2106 supported by the clip 2116 attach the second compartment 2004 to the first compartment 2002 for support. The ridge 2118, in addition to aiding in aligning the first compartment 2002 with the second compartment 2004, also supports the vertical extrusion 2112.

FIG. 12C is a side view of the second compartment 2004. The threading 2110 attaches the base 955 to the second compartment 2004. In certain embodiments the rotational position indicators 930 are on the outside of the second compartment 2004 and may be raised from the surface of the outside of the second compartment 2004 to assist in the rotation of the compartment 2004.

The fingers 2106 support the attachment of the two compartments while the vertical extrusion 2112 serves to allow the contents in each compartment to communicate. When the second compartment 2004 is rotated with respect to the first compartment 2002, the passage 2108 is rotated to a position that aligns the passage 2108 in the second compartment 2004 with a corresponding passage in the first compartment 2002. An intermediate piece such as piece 2302 may be used, such as indicated in FIGS. 11 and 11A. Once the passages are aligned, the contents in each compartment can communicate.

FIG. 12D is a bottom view of the second compartment 2004. As discussed above, the clips 2116 serve as support for the fingers 2106. The vertical extrusion 2112, including the passage 2108, allows for the communication between the first compartment 2002 and the second compartment 2004.

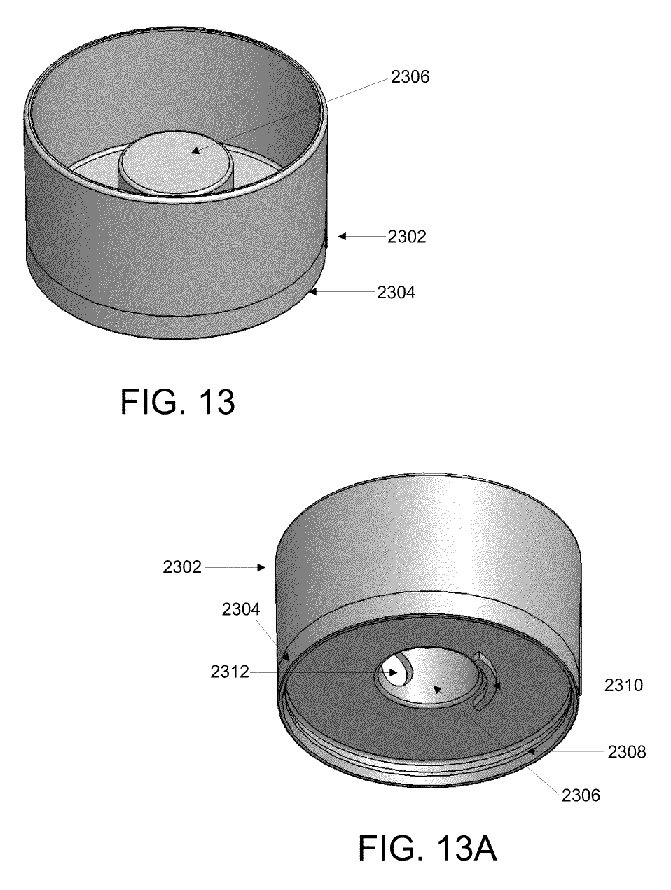

FIGS. 13 and 13A illustrate the intermediate piece 2302 of the apparatus 2000. The bottom of the first compartment 2002 is open and configured to attach to the intermediate piece 2302 by threads, snap fit, glue, plastic welding or other methods. The fingers 2106 of the second compartment attach to the intermediate piece 2302 underneath the bottom lip 2304 of the intermediate piece 2302. A vertical extrusion 2306 in the intermediate piece 2302 receives the vertical extrusion 2112 of the second compartment 2004. One of skill in the art will recognize that in certain embodiments the intermediate piece 2302 may be molded as the bottom of the first compartment 2002. In such an embodiment the intermediate piece 2302 may be omitted.

A passage 2312 in the intermediate piece 2302 provides for communication between the first compartment 2002 and the second compartment 2004. A recess 2308 on the bottom lip 2304 of the intermediate piece 2302 allows for attachment of the intermediate piece 2302 to the fingers 2106 of the second compartment 2004. In certain embodiments the ridge 2310 under the vertical extrusion 2306 is received within the ridge 2118 around the vertical extrusion 2112 on the second compartment 2004. As the second compartment 2004 is rotated, the ridge 2310 contacts the rotation stop 2315 (see FIG. 12B) to stop further rotation of the second compartment 2004.

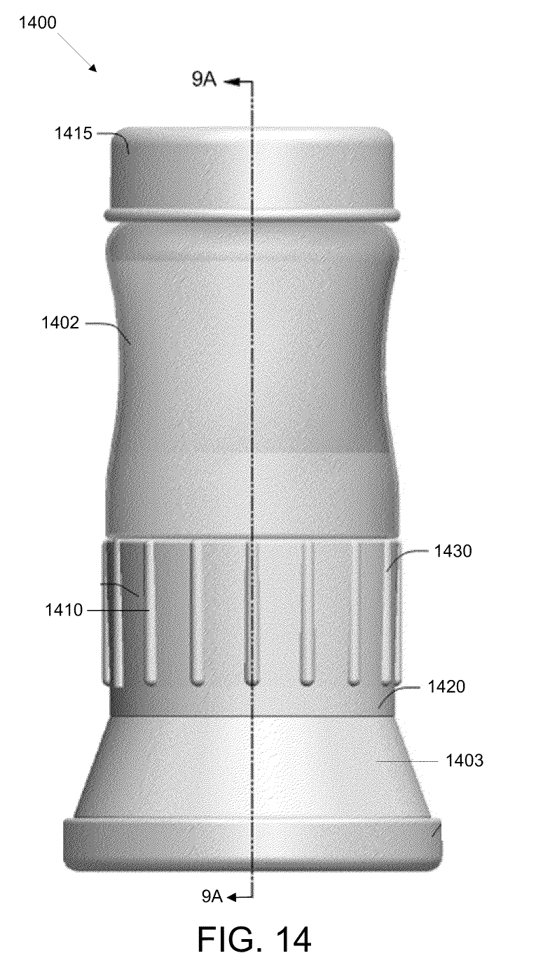

FIGS. 14-17A show another embodiment of an infant formula mixing apparatus according to the present invention. FIG. 14 shows the apparatus 1400, having a first compartment 1402, a second compartment 1403, a nipple retention ring 1415, upper section 1410 of a sealing apparatus, and a plurality of surface area modification inclusions 1430 on the upper section of the sealing apparatus.

The inclusions 1430 assist the user in rotational manipulation of the first compartment 1402 in relation to the second compartment 1403. The inclusions 1430 may further comprise a veneer coating to further assist the user in torsional manipulation. In certain embodiments the veneer may comprise of rubber, silicone, latex, or any other friction coefficient modifying material. This same veneer may also be attached to the inclusions 1430 by chemical or other mechanical means.

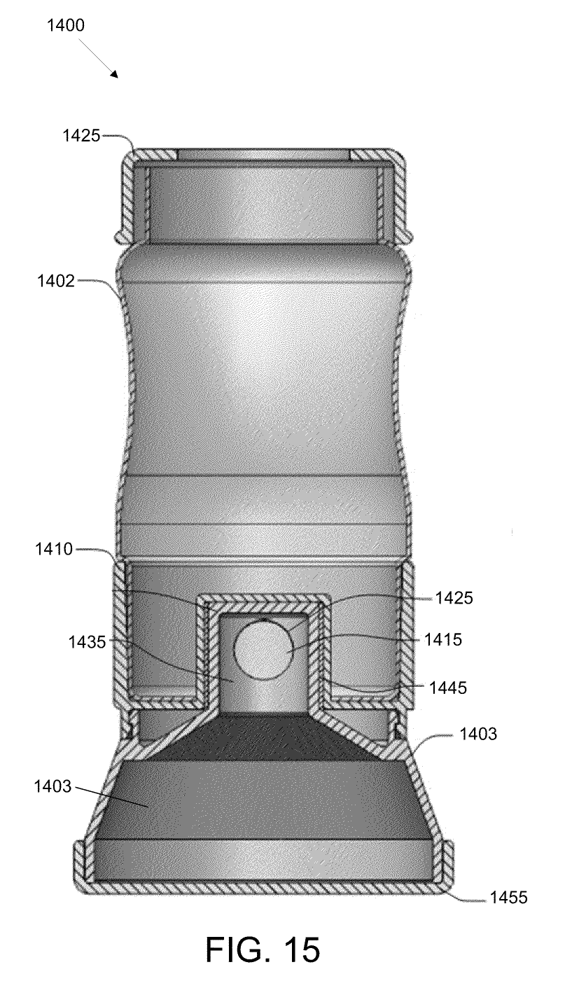

FIG. 15 depicts a cross sectional view of the apparatus 1400 taken along line 9A of FIG. 14, showing an upper section 1410, a nipple retention ring 1425, a base 1455 disposed on the bottom of the second compartment 1403, a passage 1415 disposed between the first compartment 1402 and second compartment 1403, an intermediate piece 1425 disposed between the compartments, a vertical extrusion 1435 of the second compartment 1403, and a sleeve or seal 1445 disposed between and configured to form an effective seal between the first compartment 1402 and the second compartment 1403.

In the embodiment illustrated in FIG. 15, the vertical extrusion 1435 of the second compartment 1403 is disposed along a common axis with the remaining components of the apparatus 1400. To one skilled in the art it would be apparent that the vertical extrusion 1435 might also be disposed and extruded towards the base 1455 and away from the first compartment 1402.

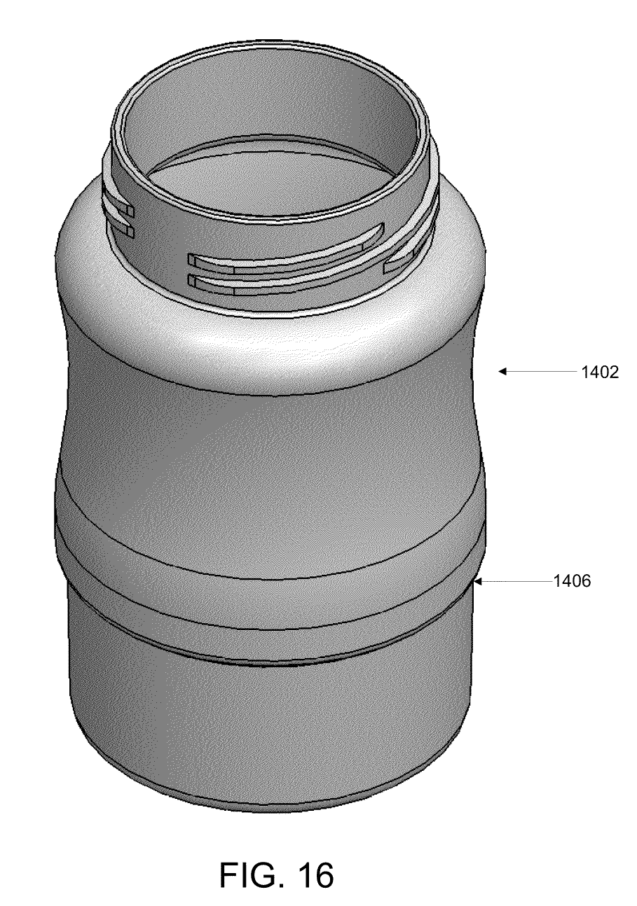

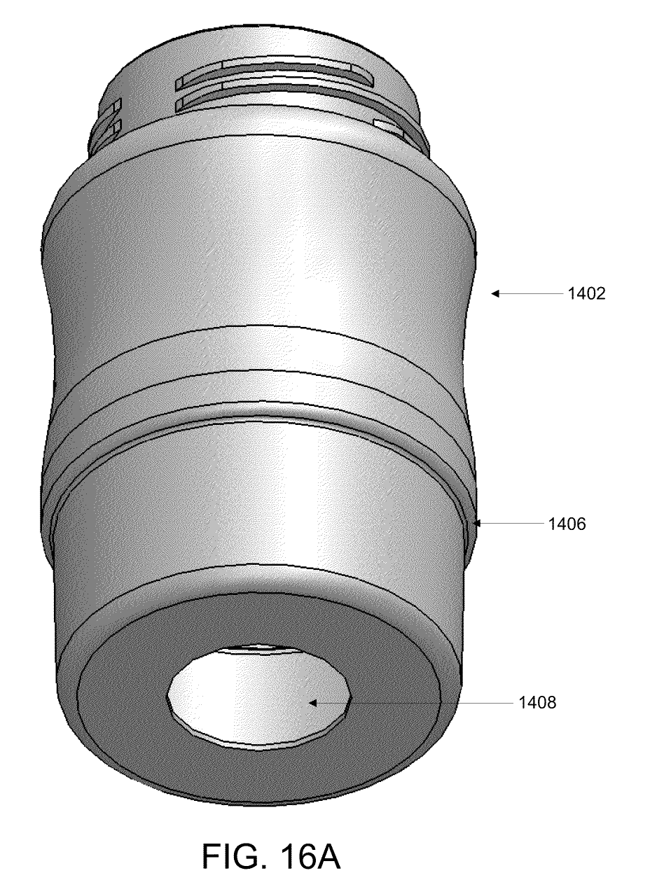

FIGS. 16 and 16A are perspective views of the first compartment 1402 of apparatus. The first compartment 1402 becomes smaller in diameter at 1406 to allow the intermediate piece 1425 to slip onto the first compartment 1402, the intermediate piece 1425 being similar to the intermediate piece 2302 of FIG. 13.

The bottom of the first compartment 1402 contains a hole 1408 into which the intermediate piece 1425, seal 1445, and vertical extrusion 1435 are placed for communication between the compartments.

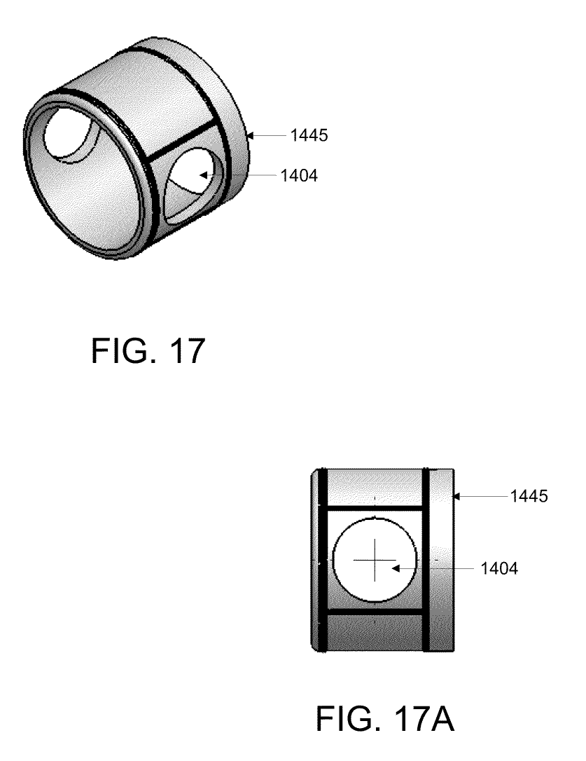

FIG. 17 is a perspective view of the sleeve 1445 and FIG. 17A is a side view of the sleeve 1445 (rotated so as to be horizontal). The sleeve 1445 contains two holes 1404 which allow communication between the first compartment 1402 and the second compartment 1403. The extrusion 1435 contains holes that can align with holes 1404. The top of the extrusion 1445 is closed such that communication between the compartments is prevented when the holes are not aligned. The intermediate piece 1425 contains similar holes, the result being that the holes align in certain rotational positions and are sealed in others.

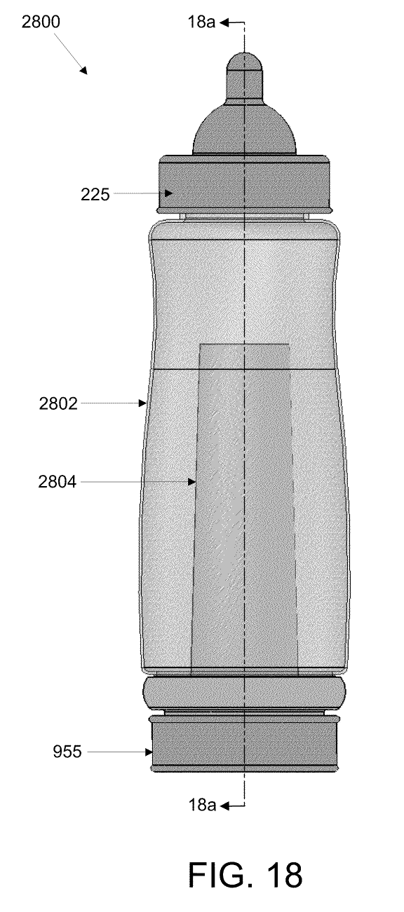

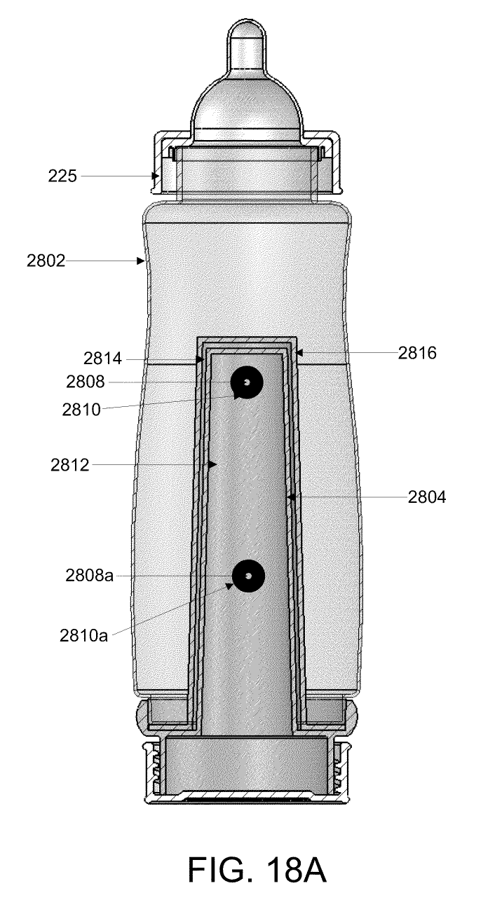

FIGS. 18 and 18A show another embodiment of the invention in an apparatus 2800 for mixing infant formula. The primary difference between this embodiment and the one described in conjunction with FIG. 14 is that the vertical portion of the communicating components between the first and second compartments has been enlarged, such that the vertical portion itself contains a significant portion of formula or water or other material.

The apparatus 2800 includes a first compartment 2802, a second compartment 2804, a nipple retention ring 225, and a base 955 disposed on the bottom of the second compartment 2804. The nipple retention ring 225 and the base 995 may be similar to the nipple retention rings and the bases in the above described embodiments. In the embodiment illustrated in FIG. 18 the second compartment 2804 is received within an interior portion of the first compartment 2802.

FIG. 18A is a cross section view of the apparatus 2800 taken along line 18a.

The first compartment 2802 includes an extrusion 2816 including passages 2808 and 2808a, which are vertically oriented relative to each other. The passages 2808 and 2808a allow material within the first compartment 2802 to flow into the space defined by the extrusion 2816.

The second compartment 2804 includes a vertical extrusion 2818 having passages 2810, 2810 corresponding to passages 2808, 2808a of the extrusion 2816. When the first compartment 2804 is rotated with respect to the second compartment 2804 to a point where the passages 2810, 2810a align with the passages 2808, 2808a, the material in the first compartment 2802 mixes with material in the second compartment 2804. The alignment/misalignment of the passages 2810, 2810a with the passages 2808, 2808a forms a multistage valve for mixing the infant formula.

A seal 2814 seals the passages 2808, 2808a from the passages 2810, 2810a when the passages 2810, 2810a and passages 2808, 2808a are misaligned.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for selectively mixing multiple substances, the apparatus comprising:
a first compartment;
a second compartment;
a first passage disposed on the first compartment and a second passage disposed on the second compartment;
wherein the first passage and second passage are located such that they can be selectively aligned to enable communication between the first compartment and the second compartment.

2. The apparatus of claim 1, wherein the first compartment and second compartment are disposed adjacent each other on an axis and configured to rotate around the axis, and wherein the first and second passages are aligned by rotating the compartments relative to each other around the axis.

3. The apparatus of claim 1, wherein the apparatus comprises a baby bottle, and wherein the first compartment is configured to contain water and the second compartment is configured to contain concentrated baby formula.

4. The apparatus of claim 3, wherein the first compartment is configured to receive repeated refilling of water, and wherein the second compartment is configured as a disposable, non-refillable cartridge.

5. The apparatus of claim 2, wherein the first and second compartments are configured to rotate to certain rotational positions relative to each other.

6. The apparatus of claim 2, further comprising a seal disposed between the first compartment and second compartment, the seal being configured to seal the first and second passages from communication with each other in a relative rotational position of the first and second compartments.

7. The apparatus of claim 2, wherein the first container and the second container are approximately cylindrical and radially coextensive, and further comprising a disc-shaped membrane and disc-shaped membrane plug disposed between the first compartment and second compartment, and further comprising a membrane aperture disposed on the membrane and a plug aperture disposed on the membrane plug, wherein the membrane aperture and plug aperture align in at least one relative rotational position of the first and second compartments.

8. The apparatus of claim 7, further comprising a plug inclusion disposed on the membrane plug, the plug inclusion receiving the membrane aperture in at least one relative rotational position of the first and second compartments.

9. The apparatus of claim 8, further comprising a disc-shaped membrane and a membrane plug disposed between the first compartment and second compartment, and a membrane aperture disposed on the membrane, wherein the membrane plug is rotationally attached to the membrane, the membrane plug covering the membrane aperture in at least one rotational position of the membrane plug.

10. The apparatus of claim 2, further comprising a disc-shaped membrane and a membrane plug disposed between the first compartment and second compartment, and a membrane aperture disposed on the membrane, wherein the membrane plug is slidably attached to the membrane, the membrane plug covering the membrane aperture in at least one sliding position of the membrane plug.

11. The apparatus of claim 2, further comprising a first vertical extrusion disposed on the bottom of the first compartment and a second vertical extrusion disposed on the top of the second compartment, the extrusions being configured to fit together in stacking arrangement, and further comprising a first aperture disposed on the first extrusion and a second aperture disposed on the second extrusion, wherein the first and second extrusions are located such that they align in at least one relative rotational position of the first and second compartments.

12. The apparatus of claim 11, further comprising a sleeve disposed between the first and second extrusions.

13. The apparatus of claim 2, wherein the first passage comprises an aperture on the bottom of the first compartment, and further comprising a vertical extrusion disposed on the top of the second compartment, the vertical extrusion being configured to fit into the aperture, and an intermediate piece substantially co-extensive with the vertical extrusion, and a first aperture on the intermediate piece and a second aperture on the vertical extrusion, wherein the first and second apertures are located such that they align in at least one relative rotational position of the first and second compartments.

14. A method of mixing baby formula, the method comprising:
filling a first compartment with water;
filling a second compartment with concentrated baby formula;
sealing the compartments relative to each other by placing them in a given rotational position along a common axis;
allowing the compartments to communicate with each other by placing them in a second rotational position relative to each other along a common axis.

15. A apparatus for mixing infant formula comprising;
means for containing a first substance;
means for containing a second substance;
means for communicating the first substance with the second substance;
means for blocking the communication means; and
means for removing the blocking means.
